(19) United States
(12) Patent Application Publication
(10) Pub. No.: US 2015/0030836 A1
(43) Pub. Date: Jan. 29, 2015

(54) POLYMERIZABLE COMPOSITION, POLYMERIZATION PRODUCT, IMAGE DISPLAY DEVICE, AND METHOD FOR PRODUCING SAME

(71) Applicant: SHOWA DENKO K.K., Minato-ku,Tokyo (JP)

(72) Inventors: Kazuhiko Ooga, Minato-ku (JP); Hiroto Kouka, Minato-ku (JP); Kenichi Nakanishi, Minato-ku (JP); Daigo Ito, Minato-ku (JP); Kazuhiro Sasaki, Minato-ku (JP); Yuta Takeuchi, Minato-ku (JP)

(73) Assignee: SHOWA DENKO K.K., Minato-ku, Tokyo (JP)

(21) Appl. No.: 14/379,216

(22) PCT Filed: Feb. 28, 2013
(86) PCT No.: PCT/JP2013/055463

§ 371 Date: Aug. 15, 2014

(30) Foreign Application Priority Data
Mar. 12, 2012 (JP) 2012-054939

(51) Int. Cl. C08F 290/04; C08L 51/00; B32B 37/24; C09J 7/00; B32B 37/18; G02F 1/00; C08L 47/00

(52) U.S. Cl. CPC C08F 290/048; G02F 1/0063; C08L 51/003; C08L 47/00; C09J 7/00; B32B 37/182; B32B 37/24; G02F 2202/023; G02F 2203/01; G02F 2202/28; C09J 151/003
USPC 428/220; 428/423.1; 428/339; 522/64; 525/310; 156/275.5; 156/60

(57) ABSTRACT

In relation to a polymerizable composition for forming a transparent optical resin layer to be interposed between an image display section of an image display device and a light-transmissive protective section thereof, the present invention provides a polymerizable composition that does not give rise to display defects caused by the deformation of the image display section, enables high-luminance, high-contrast image displaying, has excellent heat resistance, and also has a low dielectric constant. This polymerizable composition comprises: (1) a urethane (meth)acrylate obtained by reacting a hydrogenated polyolefin polyol and a compound having an isocyanato group and a (meth)acryloyl group; (2) a (meth)acryloyl-group-containing compound having a hydrocarbon group with a carbon number of 6 or greater; and (3) a photopolymerization initiator.

### TECHNICAL FIELD

The present invention relates to a polymerizable composition used in an image display device such as a liquid crystal display device used in a smartphone or PC and the like, a polymerization product obtained by polymerizing that composition, a method for producing an image display device using that composition, and an image display device produced according to that production method.

### BACKGROUND ART

At present, smartphones and tablet PCs are typically operated using a touch panel. This touch panel also serves as a display screen, and the structure of such image display devices typically consists of a layer structure in the form of a light-transmitting protective portion, a touch sensor and an image display unit such as an LCD or organic EL. A transparent optical resin layer is typically interposed between all layers or a portion of the layers of this layer structure for the purpose of protecting each layer and preventing reflection and scattering of light between layers. In addition, image display devices integrating the touch sensor with a transparent protective portion for the purpose of reducing the thickness of image display devices have been released commercially and are currently attracting attention.

Layer structures of typical examples of such an image display device are shown in FIGS. 1 and 2. An image display device 101 shown in FIG. 1 has transparent optical resin layers 106 interposed between a transparent protective portion 103 touched by the finger and a touch sensor 104 and between the touch sensor 104 and an image display portion 105 (the former is indicated as transparent optical resin layer 106a while the latter is indicated as transparent optical resin layer 106b and both of these are included in the transparent optical resin layers 106). In addition, an image display device 102 shown in FIG. 2 has the touch sensor 104 integrated on the lower surface of the transparent protective portion 103 for the purpose of reducing thickness, and has the transparent optical resin layer 106 interposed between the touch sensor 104 and the image display portion 105. The transparent optical resin layer 106b of the image display device 101 and the transparent optical resin layer 106 of the image display device 102 are required to have low dielectric constants to prevent the occurrence of operational errors by the image display portion 105 caused by changes in electrostatic capacitance when pressed with a finger.

In response to these market needs, Patent Document 1 and Patent Document 2, for example, disclose polymerizable compositions that use an esterification product of a maleic acid anhydride adduct of polyurethane acrylate or a polyisoprene polymer and 2-hydroxyethyl acrylate.

However, due to the large volumetric shrinkage during curing of curable compositions using polyurethane acrylate (in excess of 4.0%), deformation occurs in the optical glass used to interpose the liquid crystal of liquid crystal display panels caused by stress, thereby causing display defects such as orientation disturbances in the liquid crystal material. Although curable compositions using esterification products of maleic acid anhydride adducts of polyisoprene polymers and 2-hydroxyethyl methacrylate demonstrate little volumetric shrinkage during curing and have a low dielectric constant, these compositions had the problem of an increase in heat-resistant coloration of the resulting cured product.

In addition, Patent Documents 3 and 4 disclose a reaction mixture obtained by reacting 2-hydroxyethyl acrylate, hydrogenated polybutadiene diol and tolylene diisocyanate at a ratio of hydroxyl groups to isocyanato groups of greater than 1, and a photocurable moisture-proof insulating coating that contains the resulting reaction mixture and a photopolymerization initiator. However, there is no description relating to a transparent optical resin, and there is also no description relating to dielectric constant.

### PRIOR ART DOCUMENTS

### Patent Documents

Patent Document 1: Japanese Unexamined Patent Publication No. 2008-282000
Patent Document 2: Japanese Unexamined Patent Publication No. 2009-186958
Patent Document 3: Japanese Unexamined Patent Publication No. 2008-291114
Patent Document 4: Japanese Unexamined Patent Publication No. 2008-303362

### DISCLOSURE OF THE INVENTION

### Problems to be Solved by the Invention

With the foregoing in view, an object of the present invention is to provide a polymerizable composition for providing a thin image display device that does not allow the occurrence of display defects attributable to deformation of an image display portion, enables display of high luminance and high contrast images and demonstrates favorable heat resistance.

In addition, an object of the present invention is to provide an optical adhesive sheet obtained by coating this polymerizable composition to a thickness of 30 μm to 300 μm, irradiating with light enabling photosensitization of a photopolymerization initiator, and polymerizing.

In addition, an object of the present invention is to provide a method for producing an image display device using this polymerizable composition or an optical adhesive sheet obtained by polymerization thereof.

Moreover, an object of the present invention is to provide an image display device produced according to this method for producing an image display device using this polymerizable composition.

Moreover, an object of the present invention is to provide an image display device produced according to this method for producing an image display device using an optical adhesive sheet obtained by polymerizing this polymerizable composition.

### Means for Solving the Problems

As a result of conducting extensive studies to solve the aforementioned problems, the inventors of the present invention found that a photopolymerizable composition containing a (meth)acryloyl group-containing compound having a specific structure demonstrates a low level of volumetric shrinkage during polymerization, exhibits a low level of heat-resistant coloration of the resulting polymerization product due to polymerization, and demonstrates a low dielectric constant, thereby leading to completion of the present invention.

Namely, the present invention (I) relates to a polymerizable composition for forming a transparent optical resin layer interposed between an image display portion and a light-transmitting protective portion of an image display device; wherein, the polymerizable composition comprises:

(1) a urethane (meth)acrylate obtained by reacting a hydrogenated polyolefin polyol and a compound having an isocyanato group and a (meth)acryloyl group,

(2) a (meth)acryloyl group-containing compound having a hydrocarbon group having 6 or more carbon atoms, and

(3) a photopolymerization initiator.

The present invention (II) relates to a polymerization product obtained by copolymerizing the polymerizable composition of present invention (I).

The present invention (III) relates to a polymerization product used as a transparent optical resin layer interposed between an image display portion and a light-transmitting protective portion of an image display device, wherein the dielectric constant of the polymerization product under conditions of a temperature of 23° C., frequency of 100 kHz and applied voltage of 100 mV is 3.0 or less, and the color coordinate b* value described in JIS Z 8729 of the polymerization product present between two glass plates and adjusted to a thickness of 200 μm after storing under conditions of a temperature of 95° C. for 500 hours is less than 1.0.

The present invention (IV) relates to a method for producing an image display device containing a base portion having an image display portion, a light-transmitting protective portion, and a transparent optical resin layer interposed between the base portion and the protective portion; wherein, the method comprises:

a step for interposing the polymerizable composition of present invention (I) between the base portion and the protective portion, and

a step for forming a transparent optical resin layer by irradiating the polymerizable composition with light enabling photosensitization of a polymerization inhibitor.

The present invention (V) relates to a method for producing an image display device containing a base portion having an image display portion, a light-transmitting protective portion, and a transparent optical resin layer interposed between the base portion and the protective portion; wherein, the method comprises:

a step for interposing the polymerization product of present invention (III) between the base portion and the protective portion.

The present invention (VI) relates to an optical adhesive sheet obtained by coating the polymerizable composition of present invention (I) to a thickness of 30 μm to 300 μm, irradiating the composition with light enabling photosensitization of a photopolymerization initiator, and polymerizing.

The present invention (VII) relates to an optical adhesive sheet used as a transparent optical resin layer interposed between an image display portion and a light-transmitting protective portion of the image display device; wherein, the dielectric constant of the optical adhesive sheet under conditions of a temperature of 23° C., frequency of 100 kHz and applied voltage of 100 mV is 3.0 or less, and the color coordinate b* value described in JIS Z 8729 of the polymerization product present between two glass plates and adjusted to a thickness of 200 μm after storing under conditions of a temperature of 95° C. for 500 hours is less than 1.0.

The present invention (VIII) relates to a method for producing an image display device containing a base portion having an image display portion, a light-transmitting protective portion, and a transparent optical resin layer interposed between the base portion and the protective portion; wherein, the method comprises:

a step for laminating the base portion and the protective portion using the optical adhesive sheet of present invention (VI) or (VII).

The present invention (IX) relates to an image display device produced according to the method for producing an image display device of present invention (IV), (V) or (VIII).

Moreover, in other words, the present invention relates to the following [1] to [14]:

[1] a polymerizable composition for forming a transparent optical resin layer interposed between an image display portion and a light-transmitting protective portion of an image display device; wherein, the polymerizable composition comprises:

(1) a urethane (meth)acrylate obtained by reacting a hydrogenated polyolefin polyol and a compound having an isocyanato group and a (meth)acryloyl group,

(2) a (meth)acryloyl group-containing compound having a hydrocarbon group having 6 or more carbon atoms, and

(3) a photopolymerization initiator;

[2] the polymerizable composition described in [1], further comprising:

(4) at least one selected from the group consisting of a hydrogenated petroleum resin, a terpene-based hydrogenated resin, a hydrogenated rosin ester and a hydrogenated polyolefin;

[3] the polymerizable composition described in [1] or [2], further comprising:

(5) a (meth)acryloyl group-containing compound having an alcoholic hydroxyl group;

[4] the polymerizable composition described in any of [1] to [3], further comprising:

(6) a hydrogenated polyolefin polyol;

[5] the polymerizable composition described in any of [1] to [4], further comprising:

(7) a non-hydrogenated polyolefin;

[6] a polymerization product obtained by polymerizing the polymerizable composition described in any of [1] to [5];

[7] a polymerization product used as a transparent optical resin layer interposed between an image display portion and a light-transmitting protective portion of an image display device; wherein, the dielectric constant of the polymerization product under conditions of a temperature of 23° C., frequency of 100 kHz and applied voltage of 100 mV is 3.0 or less, and the color coordinate b* value described in JIS Z 8729 of the polymerization product present between two glass plates and adjusted to a thickness of 200 μm after storing under conditions of a temperature of 95° C. for 500 hours is less than 1.0;

[8] a method for producing an image display device containing a base portion having an image display portion, a light-transmitting protective portion, and a transparent optical resin layer interposed between the base portion and the protective portion; wherein, the method comprises:

a step for interposing the polymerizable composition described in any of [1] to [5] between the base portion and the protective portion, and

a step for forming a transparent optical resin layer by irradiating the polymerizable composition with light enabling photosensitization of a polymerization inhibitor;

[9] a method for producing an image display device containing a base portion having an image display portion, a light-transmitting protective portion, and a transparent optical resin layer interposed between the base portion and the protective portion; wherein, the method comprises:

a step for interposing the polymerization product described in [7] between the base portion and the protective portion;

[10] a polymerizable composition for producing an optical adhesive sheet used as a transparent optical resin layer interposed between an image display portion and a light-transmitting protective portion of an image display device, wherein the polymerizable composition is the polymerizable composition described in any of [1] to [5];

[11] an optical adhesive sheet obtained by coating the polymerizable composition described in [10] to a thickness of 30 μm to 300 μm, irradiating the composition with light enabling photosensitization of a photopolymerization initiator, and polymerizing;

[12] an optical adhesive sheet used as a transparent optical resin layer interposed between an image display portion and a light-transmitting protective portion of an image display device; wherein, the dielectric constant of the optical adhesive sheet under conditions of a temperature of 23° C., frequency of 100 kHz and applied voltage of 100 mV is 3.0 or less, and the color coordinate b* value described in JIS Z 8729 of the polymerization product present between two glass plates and adjusted to a thickness of 200 μm after storing under conditions of a temperature of 95° C. for 500 hours is less than 1.0;

[13] a method for producing an image display device containing a base portion having an image display portion, a light-transmitting protective portion, and a transparent optical resin layer interposed between the base portion and the protective portion; wherein, the method comprises:

a step for laminating the base portion and the protective portion using the optical adhesive sheet described in [11] or [12]; and,

[14] an image display device produced according to the method for producing an image display device described in any of [8], [9] and [13].

### Effects of the Invention

According to the polymerizable composition of the present invention, since stress attributable to volumetric shrinkage during polymerization can be minimized by interposing the polymerizable composition between an image display portion and light-transmitting protective portion of an image display device, the effects of this stress on the image display portion and protective portion can also be minimized. Thus, according to the image display device of the present invention, there is hardly any occurrence of warping in the image display portion and protective portion.

In addition, the polymerization product of the present invention inhibits reflection at the interface between the protective portion and polymerization product and at the interface between the polymerization product and the image display portion as a result of the refractive index thereof being close to the refractive index of a constituent panel of the image display portion or a constituent panel of the protective portion.

In addition, the polymerization product of the present invention inhibits operational errors of the image display portion by having a low dielectric constant and reducing changes in electrostatic capacitance when pressed with a finger.

As a result of the above, according to the image display device of the present invention, a high luminance, high contrast display is possible that is free of display defects.

Moreover, according to the image display device of the present invention, the device is resistant to impacts since a polymerization product is interposed between the image display portion and the protective portion.

Moreover, the polymerization product of the present invention is able to maintain a high luminance, high contrast display over a long period of time as a result of having favorable heat-resistant coloration.

In addition, according to the present invention, a thin image display device having a low working cost can be provided in which a touch sensor is integrated with a protective portion.

### BRIEF DESCRIPTION OF THE DRAWINGS

FIG. 1 is a cross-sectional view showing the essential portion of an embodiment of an image display device according to the present invention.

FIG. 2 is a cross-sectional view showing the essential portion of another embodiment of an image display device according to the present invention.

### BEST MODE FOR CARRYING OUT THE INVENTION

The following provides a detailed explanation of the present invention.

Furthermore, the term “(meth)acryloyl group” in the description refers to an acryloyl group and/or methacryloyl group.

Furthermore, the term “structural unit derived from a hydrogenated polyolefin polyol” in the description refers to a structure obtained by removing at least one alcoholic hydroxyl group from a compound having a structure obtained by hydrogen reduction of a polyolefin and having two or more alcoholic hydroxyl groups in a molecule thereof.

First, an explanation is provided of present invention (I).

Present invention (I) is a polymerizable composition for forming a transparent optical resin layer interposed between an image display portion and a light-transmitting protective portion of an image display device; wherein, the polymerizable composition comprises as essential components thereof the following components (1), (2) and (3):

component (1): a urethane (meth)acrylate obtained by reacting a hydrogenated polyolefin polyol and a compound having an isocyanato group and a (meth)acryloyl group,

component (2): a (meth)acryloyl group-containing compound having a hydrocarbon group having 6 or more carbon atoms, and

component (3): a photopolymerization initiator.

First, an explanation is provided of component (1) that is an essential component of the polymerizable composition of present invention (I).

Component (1) that is an essential component of the polymerizable composition of present invention (I) is a urethane (meth)acrylate obtained by reacting a hydrogenated polyolefin polyol and a compound having an isocyanato group and a (meth)acryloyl group.

There are no particular limitations on the component (1) that is an essential component of the polymerizable composition of present invention (I) provided it is a compound having a structural unit derived from a hydrogenated polyolefin polyol, one or two urethane bonds, and a number of (meth)acryloyl groups equal to the number of urethane bonds in a molecule thereof.

There are no particular limitations on the hydrogenated polyolefin polyol able to serve as a raw material of component (1) that is an essential component of the polymerizable composition of present invention (I) provided it is a compound that has a structure obtained by hydrogen reduction of a polyolefin and has two or more alcoholic hydroxyl groups in a molecule thereof.

Examples of hydrogenated polyolefin polyols able to serve as a raw material of component (1) that is an essential component of the polymerizable composition of present invention (I) include hydrogenated polybutadiene polyols and hydrogenated polyisoprene polyols.

Hydrogenated polybutadiene polyols refer to compounds obtained by hydrogen reduction of a polybutadiene polyol. Although 1,2-polybutadiene polyol is typically subjected to hydrogen reduction, it is preferably not crystalline. Examples of hydrogenated polybutadiene polyols include GI-1000, GI-2000 and GI-3000 manufactured by Nippon Soda Co., Ltd.

Hydrogenated polyisoprene polyols refer to compounds obtained by hydrogen reduction of a polyisoprene polyol. Examples of hydrogenated polyisoprene polyols include Epol manufactured by Idemitsu Kosan Co., Ltd.

There are no particular limitations on the compound having an isocyanato group and a (meth)acryloyl group that is able to serve as a raw material of component (1) that is an essential component of the polymerizable composition of present invention (I) provided it is a compound that has an isocyanato group and a (meth)acryloyl group in a molecule thereof.

Examples of compounds having an isocyanato group and a (meth)acryloyl group able to serve as a raw material of component (1) that is an essential component of the polymerizable composition of present invention (I) include 2-isocyanatoethyl acrylate and 2-isocyanatoethyl methacrylate.

Examples of 2-isocyanatoethyl acrylate include Karenz AOI manufactured by Showa Denko K.K.

Examples of 2-isocyanatoethyl methacrylate include Karenz MOI manufactured by Showa Denko K.K.

The urethane (meth)acrylate of component (1) that is an essential component of the polymerizable composition of present invention (I) obtained by reacting the hydrogenated polyolefin polyol and compound having an isocyanato group and a (meth)acryloyl group of component (1) is synthesized according to the method indicated below.

Furthermore, all of the hydroxyl groups of the hydrogenated polyolefin polyol may be reacted with the compound having an isocyanato group and a (meth)acryloyl group, or only a portion of the hydroxyl groups of the hydrogenated polyolefin polyol may be reacted with the compound having an isocyanato group and a (meth)acryloyl group, while leaving a portion of the hydroxyl groups unreacted.

In the case of reacting all of the hydroxyl groups of the hydrogenated polyolefin polyol with the compound having an isocyanato group and a (meth)acryloyl group, the ratio between the total number of hydroxyl groups of the hydrogenated polyolefin polyol and the total number of isocyanato groups of the compound having an isocyanato group and a (meth)acryloyl group used is required to be 1 or more.

In the case of reacting only a portion of the hydroxyl groups of the hydrogenated polyolefin polyol with the compound having an isocyanato group and a (meth)acryloyl group while leaving a portion of the hydroxyl groups unreacted, the total number of isocyanato groups of the compound having an isocyanato group and a (meth)acryloyl group used is required to be less than the total number of hydroxyl groups of the hydrogenated polyolefin polyol charged in the reaction.

Furthermore, although the remaining hydrogenated polyolefin polyol can be allowed to be present as is without reacting with the compound having an isocyanato group and (meth)acryloyl group at this time, this hydrogenated polyolefin polyol is included in the hydrogenated polyolefin polyol of component (6).

Although there are no particular limitations on the production method, the hydrogenated polyolefin polyol, a polymerization inhibitor and, as necessary, a urethanation catalyst and antioxidant are typically added and placed in a reaction vessel followed by initiating stirring and raising the temperature inside the reaction vessel to 40° C. to 120° C. and preferably 50° C. to 100° C. Subsequently, the compound containing an isocyanato group and a meth(acryloyl) group is added by dropping therein. During dropping, the temperature within the reaction vessel is controlled to 40° C. to 130° C. and preferably to 50° C. to 110° C. Following completion of dropping, the temperature in the reaction vessel is maintained at 40° C. to 120° C., and preferably at 50° C. to 100° C., while continuing to stir to complete the reaction.

Next, an explanation is provided of component (2) that is an essential component of present invention (I).

The component (2) that is an essential component of present invention (I) is a (meth)acryloyl group-containing compound having a hydrocarbon group having 6 or more carbon atoms.

Examples of (meth)acryloyl group-containing compounds having a hydrocarbon group having 6 or more carbon atoms include (meth)acryloyl group-containing compounds having an aromatic group such as benzyl methacrylate, (meth)acryloyl group-containing compounds having a cyclic aliphatic group such as cyclohexyl acrylate, isobornyl acrylate, dicyclopentenyl acrylate, dicyclopentenyloxyethyl acrylate, dicyclopentanyl acrylate, dicyclopentanylethyl acrylate, 4-tert-butylcyclohexyl acrylate, dicyclohexyl methacrylate, isobornyl methacrylate, dicyclopentenyl methacrylate, dicyclopentenyloxyethyl methacrylate, dicyclopentanyl methacrylate, dicyclopentanylethyl methacrylate or 4-tert-butylcyclohexyl methacrylate, and (meth)acryloyl group-containing compounds having a linear aliphatic group such as methoxytriethylene acrylate, ethyl carbitol acrylate, lauryl acrylate, isononyl acrylate, 2-propylheptyl acrylate, 4-methyl-2-propylhexyl acrylate, lauryl methacrylate, isononyl methacrylate, 2-propylheptyl methacrylate or 4-methyl-2-propylhexyl methacrylate.

Among these, cyclohexyl acrylate, isobornyl acrylate, dicyclopentanyl acrylate, dicyclopentanyloxyethyl acrylate, cyclohexyl methacrylate, isobornyl methacrylate, dicyclopentanyl methacrylate, dicyclopentanylethyl methacrylate, dicyclopentanylethyl methacrylate, methoxytriethylene acrylate, ethyl carbitol acrylate, lauryl acrylate, isononyl acrylate, 2-propylheptyl acrylate, 4-methyl-2-propylhexyl acrylate, lauryl methacrylate, isononyl methacrylate, 2-propylheptyl methacrylate and 4-methyl-2-propylhexyl methacrylate are preferable in consideration of heat-resistant coloration performance, lauryl acrylate, isononyl acrylate, 2-propylheptyl acrylate, 4-methyl-2-propylhexyl acrylate, isononyl methacrylate, 2-propylheptyl methacrylate and 4-methyl-2-propylhexyl methacrylate are more preferable in consideration of the dilution efficiency of a component (4) to be subsequently described, and lauryl acrylate, isononyl acrylate, 2-propylheptyl acrylate and 4-methyl-2-propylhexyl acrylate are particularly preferable in consideration of photopolymerization rate.

The amount of component (2) used is preferably 10% by weight to 30% by weight, more preferably 13% by weight to 25% by weight, and particularly preferably 15% by weight to 22% by weight, based on the total weight of the polymerizable composition of present invention (I). If the amount of component (2) used is less than 10% by weight based on the total weight of the polymerizable composition of present invention (I), the viscosity of the polymerizable composition of present invention (I) may be become high, thereby making this undesirable. In addition, if the amount of component (2) used is greater than 30% by weight based on the total weight of the polymerizable composition of present invention (I), there is the possibility of volumetric shrinkage increasing during polymerization of the polymerizable composition of present invention (I), thereby making this undesirable.

Next, an explanation is provided of component (3) that is an essential component of present invention (I).

Component (3) that is an essential component of present invention (I) is a photopolymerization initiator.

There are no particular limitations on the photopolymerization initiator of component (3) provided it is a compound that generates radicals that contribute to initiation of radical polymerization as a result of being irradiated with near infrared light, visible light or ultraviolet light and the like.

Examples of the photopolymerization initiator of component (3) include acetophenone, 2,2-dimethoxy-2-phenylacetophenone, diethoxyacetophenone, 1-hydroxycyclohexyl phenyl ketone, 1,2-hydroxy-2-methyl-1-phenylpropan-1-one, α-hydroxycyclohexyl phenyl ketone, 2-hydroxy-2-methyl-1-phenylpropan-1-one, 2-hydroxy-2-methyl-1-(4-isopropylphenyl)propane-1-one, 2-hydroxy-2-methyl-1-(4-dodecylphenyl)propane-1-one and 2-hydroxy-2-methyl-1-[(2-hydroxyethoxy)phenyl]propanone, benzophenone, 2-methylbenzophenone, 3-methylbenzophenone, 4-methylbenzophenone, 4-methoxybenzophenone, 2-chlorobenzophenone, 4-chlorobenzophenone, 4-bromobenzophenone, 2-carboxybenzophenone, 2-ethoxycarbonylbenzophenone, 4-benzoyl-4′-methyldiphenyl sulfide, benzophenone tetracarboxylic acids or tetramethyl esters thereof, 4,4′-bis(dialkylamino)benzophenones (such as 4,4′-bis(dimethylamino)benzophenone, 4,4′-bis(dicyclohexylamino)benzophenone, 4,4′-bis(diethylamino)benzophenone or 4,4′-bis(dihydroxyethylamino)benzophenone), 4-methoxy-4′-dimethylaminobenzophenone, 4,4′-dimethoxybenzophenone, 4-dimethylaminobenzophenone, 4-dimethylaminoacetophenone, benzyl, anthraquinone, 2-t-butylanthraquinone, 2-methylanthraquinone, phenanthraquinone, fluorenone, 2-benzyl-2-methoxyamino-1-(4-morpholinophenyl)-1-butanone, 2-(dimethylamino)-2-[(4-methylphenyl)methyl]-1-[4-(4-morpholinyl)phenyl]-1-butanone, 2-methyl-1-[4-(methylthio)phenyl]-2-morpholino-1-propanone, 2-hydroxy-2-methyl-[4-(1-methylvinyl)phenyl]propanol oligomer, benzoin, benzoin ethers (such as benzoin methyl ether, benzoin ethyl ether, benzoin propyl ether, benzoin isopropyl ether, benzoin isobutyl ether, benzoin phenyl ether or benzyl dimethyl ketal), acridone, chloroacridone, N-methylacridone, N-butylacridone, N-butyl-chloroacridone, 2,4,6-trimethylbenzoyl diphenyl phosphine oxide, 2,6-dimethoxybenzoyl diphenyl phosphine oxide, 2,6-dichlorobenzoyl diphenyl phosphine oxide, 2,4,6-trimethylbenzoyl methoxyphenyl phosphine oxide, 2,4,6-trimethylbenzoyl ethoxyphenyl phosphine oxide, 2,3,5,6-tetramethylbenzoyl diphenyl phosphine oxide, and benzoyldi-(2,6-dimethylphenyl)phosphonate. Examples of bis(acyl)phosphine oxides include bis(2,6-dichlorobenzoyl) phenyl phosphine oxide, bis(2,6-dichlorobenzoyl) phenyl phosphine oxide, bis(2,6-dichlorobenzoyl)-2,5-dimethyl phenyl phosphine oxide, bis(2,6-dichlorobenzoyl)-4-propyl phenyl phosphine oxide, bis(2,6-dichlorobenzoyl)-1-naphthyl phosphine oxide, bis(2,6-dimethoxybenzoyl) phenyl phosphine oxide, bis(2,6-dimethoxybenzoyl)-2,4,4-trimethylpentyl phosphine oxide, bis(2,6-dimethoxybenzoyl)-2,5-dimethylphenyl phosphine oxide, bis-(2,4,6-trimethylbenzoyl)phenyl phosphine oxide, 2,5,6-trimethylbenzoyl)-2,4,4-trimethylpentyl phosphine oxide, 2-isopropylthioxanthone, 4-isopropylthioxanthone, 2,4-diethylthioxanthone, 2,4-dichlorothioxanthone and 1-chloro-4-propoxythioxanthone.

In addition, a metallocene compound can also be used as a photopolymerization initiator. Examples of metallocene compounds include those in which the central metal is a transition metal such as that represented by Fe, Ti, V, Cr, Mn, Co, Ni, Mo, Ru, Rh, Lu, Ta, W, Os or Ir, and examples thereof include bis(η5-2,4-cyclopentadien-1-yl)-bis[2,6-difluoro-3-(pyrrol-1-yl)phenyl]titanium.

These photopolymerization initiators can each be used alone or two or more types can be used in combination.

Among these, 2-hydroxy-2-methyl-1-phenylpropan-1-one, 1-hydroxycyclohexyl phenyl ketone, 2,4,6-trimethylbenzoyl diphenyl phosphine oxide and 2,3,5,6-tetramethylbenzoyl diphenyl phosphine oxide are preferable, 1-hydroxycyclohexyl phenyl ketone and 2,4,6-trimethylbenzoyl diphenyl phosphine oxide are particularly preferable, and 2,4,6-trimethylbenzoyl diphenyl phosphine oxide used alone or the combined use of 1-hydroxycyclohexyl phenyl ketone and 2,4,6-trimethylbenzoyl diphenyl phosphine oxide is most preferable.

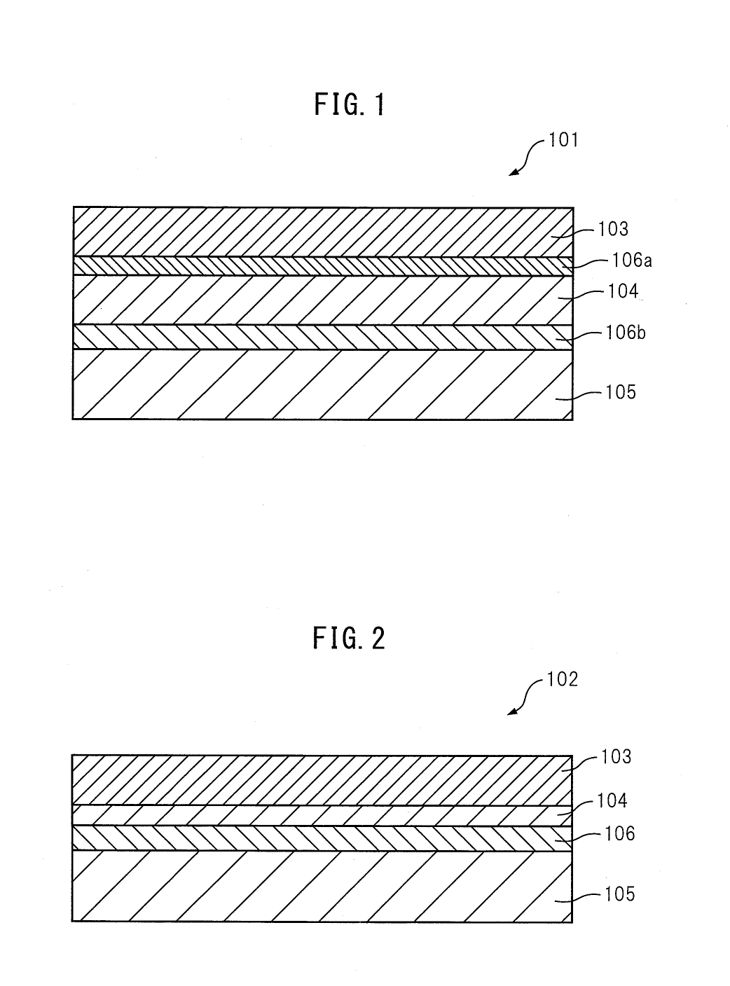

In addition, the light-transmitting protective portion 103 shown in FIG. 1 and FIG. 2 is frequently imparted with a function that blocks out light in the ultraviolet range from the viewpoint of protecting the image display portion 105 from ultraviolet light. In this case, a photopolymerization initiator capable of being photosensitized in the visible range as well in the form of 2,4,6-trimethylbenzoyl diphenyl phosphine oxide or 2,3,5,6-tetramethylbenzoyl diphenyl phosphine oxide is used preferably, and 2,4,6-trimethylbenzoyl diphenyl phosphine oxide is particularly preferable.

The amount of component (3) used is preferably 0.1% by weight to 4.0% by weight, more preferably 0.3% by weight to 3.0% by weight, and particularly preferably 0.5% by weight to 2.0% by weight, based on the total weight of the polymerizable composition of present invention (I). If the amount of component (3) used is less than 0.1% by weight based on the total weight of the polymerizable composition of present invention (I), the photopolymerization performance of the photopolymerization initiator may be inadequate, thereby making this undesirable. In addition, if the amount of component (3) used is greater than 4.0% by weight, the polymerization product of present invention (II) to be subsequently described may be easily colored in the case of being placed in a high-temperature environment, thereby making this undesirable.

Moreover, the polymerizable composition of present invention (I) is also able to preferably contain component (4) as indicated below.

Component (4) is at least one selected from the group consisting of a hydrogenated petroleum resin, a terpene-based hydrogenated resin, a hydrogenated rosin ester and a hydrogenated polyolefin.

A hydrogenated petroleum resin refers to a resin obtained by hydrogen reduction of a petroleum-based resin. Examples of raw materials of the hydrogenated petroleum resin in the form of a petroleum-based resin include aliphatic petroleum resins, aromatic petroleum resins, aliphatic-aromatic petroleum resins, alicyclic petroleum resins, dicyclopentadiene resins and modified forms thereof such as hydrogenated forms. Synthetic petroleum resins may be C5-based or C9-based resins.

A terpene-based hydrogenated resin refers to resin obtained by hydrogen reduction of a terpene-based resin. Examples of raw materials of terpene-based hydrogenated resins in the form of terpene-based resins include β-pinene resins, α-pinene resins, β-limonene resins, α-limonene resins, pinene-limonene copolymer resins, pinene-limonene-styrene copolymer resins, terpene-phenol resins and aromatic-modified terpene resins. Many of these terpene-based resins are resins that do not have a polar group.

A hydrogenated rosin ester refers to a resin obtained by hydrogen reduction of a rosin ester obtained by esterifying a hydrogenated rosin obtained by hydrogenating a rosin-based resin or esterifying a rosin. Examples of rosin-based resin tackifiers include gum rosin, tall oil rosin, wood rosin, disproportionated rosin, polymerized rosin and modified rosins such as rosin maleate.

A hydrogenated polyolefin refers to a compound obtained by hydrogen reduction of a polyolefin.

Examples of hydrogenated polyolefins include hydrogenated polybutadiene, hydrogenated polyisoprene and hydrogenated polybutene.

Hydrogenated polybutadiene refers to a compound obtained by hydrogen reduction of polybutadiene. Although 1,2-polybutadiene is typically subjected to hydrogen reduction, it is preferably not crystalline. In the case of using in the polymerizable composition of present invention (I), the number average molecular weight is preferably 30,000 or less since this does not cause an excessive increase in the viscosity of the polymerizable composition of present invention (I).

Hydrogenated polyisoprene refers to a compound obtained by hydrogen reduction of polyisoprene. The number average molecular weight is preferably 30,000 or less since this does not cause an excessive increase in the viscosity of the polymerizable composition of present invention (I).

Hydrogenated polybutene refers to a compound obtained by hydrogen reduction of polybutene. The number average molecular weight is preferably 30,000 or less since this does not cause an excessive increase in the viscosity of the polymerizable composition of present invention (I).

These compounds of component (4) can each be used alone or two or more types can be used in combination.

Preferable examples of these compounds include hydrogenated petroleum resins, terpene-based hydrogenated resins and combinations of hydrogenated petroleum resins or terpene-based hydrogenated resins and hydrogenated polyolefins, while more preferable examples include terpene-based hydrogenated resins and combinations of terpene-based hydrogenated resins and hydrogenated polyolefins.

In addition, among these terpene-based hydrogenated resins, terpene-based hydrogenated resins not having an aromatic ring, such as β-pinene resins, α-pinene resins, β-limonene resins, α-limonene resins or pinene-limonene copolymer resins, are preferable since they undergo little coloration in the case of having been stored in a high-temperature environment.

In the case of using component (4) in the polymerizable composition of present invention (I), although unable to be unconditionally defined because of depending on components other than component (4) present in the composition, the amount of component (4) used is such that the total amount of component (1) and component (4) is preferably 40% by weight to 90% by weight, more preferably 41% by weight to 87% by weight, and particularly preferably 43% by weight to 85% by weight, based on the total weight of the polymerizable composition of present invention (I). In the case the total amount of component (1) and component (4) is less than 40% by weight based on the total weight of the polymerizable composition of present invention (I), volumetric shrinkage increases during polymerization, thereby making this undesirable. In addition, if the total amount of component (1) and component (4) is greater than 90% by weight based on the total weight of the polymerizable composition of present invention (I), the viscosity of the polymerizable composition of present invention (I) tends to increase, thereby making this undesirable.

Moreover, the polymerizable composition of present invention (I) is also able to preferably contain a component (5) as indicated below.

Component (5) is an acryloyl group-containing compound having an alcoholic hydroxyl group.

There are no particular limitations on component (5) provided it is a compound having an alcoholic hydroxyl group and acryloyl group within the same molecule.

Examples of acryloyl group-containing compounds having an alcoholic hydroxyl group include 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, 2-hydroxy-3-(o-phenylphenoxy)propyl acrylate, 2-hydroxyethyl acrylamide, 2-hydroxyethyl methacrylate, 2-hydroxypropyl methacrylate, 3-hydroxypropyl methacrylate, 2-hydroxybutyl methacrylate, 4-hydroxybutyl methacrylate, 2-hydroxy-3-phenoxypropyl methacrylate and 2-hydroxy-3-(o-phenylphenoxy)propyl methacrylate.

Among these, when considering compatibility in the case of using in the polymerizable composition of present invention (I), 2-hydroxyethyl acrylate, 4-hydroxybutyl acrylate, 2-hydroxy-3-phenoxypropyl acrylate, 2-hydroxy-3-(o-phenylphenoxy)propyl acrylate, 2-hydroxypropyl methacrylate, 3-hydroxypropyl methacrylate, 2-hydroxybutyl methacrylate and 4-hydroxybutyl methacrylate are preferable, 4-hydroxypropyl acrylate, 2-hydroxypropyl methacrylate, 3-hydroxypropyl methacrylate, 2-hydroxybutyl methacrylate and 4-hydroxybutyl methacrylate are more preferable, and 2-hydroxypropyl methacrylate is most preferable.

Moreover, the polymerizable composition of present invention (I) is also able to preferably contain a component (6) as indicated below.

Component (6) is a hydrogenated polyolefin polyol.

Component (6) is used to increase compatibility of component (1), component (4) and component (5). In addition, it is also preferably used in cases in which it is necessary to lower the dielectric constant of the polymerization product of present invention (II) to be subsequently described and for the purpose of further inhibiting volumetric shrinkage during polymerization.

The hydrogenated polyolefin polyol is the same as the hydrogenated polyolefin polyol able to be used as a raw material of component (1) that is an essential raw material of the polymerizable composition of present invention (I).

Component (6) is preferably used by combining a hydrogenated polyolefin polyol with at least one of a hydrogenated petroleum resin and terpene-based hydrogenated resin, and is most preferably used by combining a hydrogenated polyolefin polyol with a terpene-based hydrogenated resin.

Moreover, the polymerizable composition of present invention (I) is also able to preferably contain a component (7) as indicated below.

Component (7) is a non-hydrogenated polyolefin.

Component (7) is used to increase the compatibility of component (1), component (4) and component (5), and reduce viscosity by a dilution effect.

Examples of non-hydrogenated polyolefins include polybutadiene, polyisoprene, polybutene, α-olefin polymers and ethylene-α-olefin copolymers.

In addition, volumetric shrinkage of the polymerizable composition of present invention (I) during polymerization is preferably 4.0% or less and more preferably 3.0% or less. In the case volumetric shrinkage of the polymerizable composition of present invention (I) during polymerization is greater than 4.0%, internal stress that accumulates in the polymerization product during polymerization of the polymerizable composition becomes excessively large, and warping occurs at the interface between the transparent optical resin layer 106 and the light-transmitting protective portion 103, the touch sensor 104 or the image display portion 105, thereby making this undesirable.

The tensile elasticity of the polymerization product at 23° C. is preferably 1×10⁷ Pa or less and more preferably 1×10³ Pa to 1×10⁶ Pa.

Furthermore, tensile elasticity as described in the present description refers to the value when testing is carried out at a tension speed of 500 mm/min.

If the tensile elasticity of the polymerization product at 23° C. is greater than 1×10⁷ Pa, warping may occur during polymerization of the polymerizable composition due to the effect of stress attributable to volumetric shrinkage on the light-transmitting protective portion 103, the touch sensor 104 or the image display portion 105, thereby making this undesirable.

The viscosity of the polymerizable composition of present invention (I) at 25° C. is preferably 5000 mPa·s or less and more preferably 4000 mPa·s or less.

Furthermore, viscosity as described in the present description refers to the value measured using a cone and plate type viscometer (Model DV-11+ Pro, Brookfield Engineering Inc., spindle type: CPE-42) under conditions of a temperature of 25° C. and rotating speed of 10 rpm.

If the viscosity of the polymerizable composition of present invention (I) at 25° C. is higher than 5000 mPa·s, spreading after coating is inhibited in the case of coating the polymerizable composition of present invention (I) by a draw coating method using a dispenser, and as a result thereof, the composition may be unable to be applied at a uniform thickness at a required location, thereby making this undesirable.

A polymerization inhibitor, antioxidant, antifoaming agent or modifier and the like can be arbitrarily added to the polymerizable composition of present invention (I) as necessary.

Although there are no particular limitations thereon, examples of polymerization inhibitors include phenothiazine, hydroquinone, p-methoxyphenol, p-benzoquinone, naphthoquinone, phenanthraquinone, toluquinone, 2,5-diacetoxy-p-benzoquinone, 2,5-dicaproxy-p-benzoquinone, 2,5-acyloxy-p-benzoquinone, p-t-butylcatechol, 2,5-di-t-butylhydroquinone, p-tert-butylcatechol, mono-t-butylhydroquinone, 2,5-di-t-amylhydroquinone, di-t-butyl.paracresolhydroquinone monomethyl ether, α-naphthol, acetamidine acetate, acetamidine sulfate, phenyl hydrazine hydrochloride, hydrazine hydrochloride, trimethylbenzyl ammonium chloride, lauryl pyridinium chloride, cetyltrimethyl ammonium chloride, phenyltrimethyl ammonium chloride, trimethylbenzyl ammonium oxalate, di(trimethylbenzyl ammonium) oxalate, trimethylbenzyl ammonium maleate, trimethylbenzyl ammonium tartrate, trimethylbenzyl ammonium glycolate, phenyl-β-naphthylamine, para-benzylaminophenol, di-β-naphthyl-para-phenylene diamine, dinitrobenzene, trinitrotoluene, picric acid, cyclohexanone oxime, pyrogallol, tannic acid, resorcin, triethylamine hydrochloride, dimethylaniline hydrochloride and butylamine hydrochloride.

These can be used alone or two or more types can be suitably used in combination.

Among these, hydroquinone, p-methoxyphenol, p-benzoquinone, naphthoquinone, 2,5-diacetoxy-p-benzoquinone, 2,5-dicaproxy-p-benzoquinone, 2,5-acyloxy-p-benzoquinone, p-t-butylcatechol, 2,5-di-t-butylhydroquinone, p-tert-butylcatechol, mono-t-butylhydroquinone, 2,5-di-t-amylhydroquinone, di-t-butyl.paracresolhydroquinone monomethyl ether and phenothiazine are used preferably.

Normally, the amount of polymerization inhibitor can be adjusted so that the added amount thereof is 0.01% by weight to 5% by weight based on the total weight of the polymerizable composition of present invention (I). However, the amount of polymerization inhibitor is a value that is determined in consideration of the amount of polymerization inhibitor preliminarily contained in component (2) and component (5). Namely, although a polymerization inhibitor is typically preliminarily contained in component (2) and component (5) of present invention (I), the amount obtained by combining the total amount of this polymerization inhibitor and the amount of polymerization inhibitor newly added refers to the added amount of 0.01% by weight to 5% by weight based on the total weight of the polymerizable composition of present invention (I).

There are no particular limitations on the antioxidant, and examples thereof include pentaerythritol tetrakis[3-(3,5-di-tert-butyl-4-hydroxyphenyl)propionate], octadecyl-3-(3,5-di-tert-butyl-4-hydroxyphenyl)propionate, thiodiethylene bis[3-(3,5-di-tert-butyl-4-hydroxyphenyl)propionate], alkyl esters having 7 to 9 carbon atoms of 3,5-di-tert-butyl-4-hydroxybenzene propionate, 4,6-bis(octylthiomethyl)-o-cresol, 3,9-bis[2-[3-(3-tert-butyl-4-hydroxy-5-methylphenyl)propionyloxy]-1,1-dimethylethyl]-2,4,8,10-tetraoxaspiro[5,5]-undecane, 2,2′-methylenebis(6-tert-butyl-4-methylphenol), 4,4′-butylidene(6-tert-butyl-3-methylphenol), 4,4′-thiobis(2-tert-butyl-5-methylphenol), N,N′,N″-tris(3,5-di-tert-butyl-4-hydroxybenzyl)isocyanurate and 1,1,3-tris(2-methyl-4-hydroxy-5-tert-butylphenyl)butane. Among these, pentaerythritol tetrakis[3-(3,5-di-tert-butyl-4-hydroxyphenyl)propionate] and octadecyl-3-(3,5-di-tert-butyl-4-hydroxyphenyl) propionate are preferable, and pentaerythritol tetrakis[3-(3,5-di-tert-butyl-4-hydroxyphenyl)propionate] is most preferable.

Normally, the amount of antioxidant can be adjusted so that the added amount thereof is 0.01% by weight to 5% by weight based on the total weight of the polymerizable composition of present invention (I). However, the amount of polymerization inhibitor is a value that is determined in consideration of the amount of polymerization inhibitor preliminarily contained in other components such as component (4). Namely, although there are cases in which antioxidant is preliminarily contained in component (4) and the like of present invention (I), the amount obtained by combining the total amount of this polymerization inhibitor and polymerization inhibitor newly added refers to the added amount of 0.01% by weight to 5% by weight based on the total weight of the polymerizable composition of present invention (I).

Examples of the modifier include leveling agents for improving leveling. Examples of leveling agents that can be used include polyether-modified dimethylpolysiloxane copolymers, polyester-modified dimethylpolysiloxane copolymers, polyether-modified methylalkylpolysiloxane copolymers, aralkyl-modified methylalkylpolysiloxane copolymers and acrylic ester copolymers. These may be used alone or two or more types may be used in combination. These leveling agents can be added at 0.01% by weight to 5% by weight based on the total weight of the polymerizable composition of present invention (I). In the case the added amount is less than 0.01% by weight, there is the possibility of the effect of adding the leveling agent not being demonstrated. In addition, in the case the added amount is greater than 5% by weight, the polymerizable composition of present invention (I) may become turbid, thereby making this undesirable.

There are no particular limitations on the antifoaming agent provided it has an action that eliminates or inhibits air bubbles generated or remaining when coating the polymerizable composition of present invention (I).

Examples of antifoaming agents used in the polymerizable composition of present invention (I) include known antifoaming agents such as acetylene diol-based compounds that inhibit the polymerizable composition of present invention (I) from becoming turbid. Specific examples thereof include acrylic polymer-based antifoaming agents such as Dappo SN-348 (San Nopco Co., Ltd.), Dappo SN-354 (San Nopco Co., Ltd.), Dappo SN-368 (San Nopco Co., Ltd.) or Disparlon 230HF (Kusumoto Kasei Co., Ltd.), and acetylene diol-based antifoaming agents such as Surfinol DF-110D (Shin-Etsu Chemical Co., Ltd.) or Surfinol DF-37 (Shin-Etsu Chemical Co., Ltd.). These may be used alone or two or more types may be used in combination. Normally, antifoaming agents can be added at 0.001% by weight to 5% by weight based on the total weight of the polymerizable composition of present invention (I). If the added amount is less than 0.001% by weight, there is the possibility of the effect of adding the antifoaming agent not being demonstrated. In addition, if the added amount is greater than 5% by weight, the polymerizable composition of present invention (I) may become turbid, thereby making this undesirable.

Next, an explanation is provided of the polymerization product of present invention (II).

Present invention (II) is a polymerization product obtained by polymerizing the polymerizable composition of present invention (I).

A specific example of a method for producing the polymerization product of present invention (II) consists of first coating the polymerizable composition of present invention (I) onto a base material using a dispenser and the like. Next, the aforementioned base material and another base material are layered so as to sandwich the polymerizable composition with spacers interposed there between, followed by polymerizing the polymerizable composition of present invention (I) by irradiating with light enabling photosensitization of a photopolymerization initiator through either of the aforementioned base materials using a high-pressure mercury lamp, metal halide lamp or LED and the like for the light source to obtain the polymerization product of present invention (II).

The refractive index of the polymerization product of present invention (II) at 25° C. is preferably 1.45 to 1.55 and more preferably 1.48 to 1.52. In the case the refractive index at 25° C. is less than 1.45 or greater than 1.55, since this refractive index becomes excessively low in comparison with the refractive index of the material of the light-transmitting protective portion in the form of optical glass or an acrylic resin such as polymethyl methacrylate, the difference in refractive index at the interface extending between the image display portion to the light-transmitting protective portion becomes somewhat large, and scattering and attenuation of image light from the image display portion also become somewhat large, thereby making this undesirable.

Next, an explanation is provided of the polymerization product of prevent invention (III).

The polymerization product of present invention (III) is a polymerization product used as a transparent optical resin layer interposed between the image display portion and light-transmitting protective portion of an image display device.

The dielectric constant of the polymerization product of present invention (III) at 23° C. under conditions of a frequency of 100 kHz and applied voltage of 100 mV is preferably 3.2 or less and more preferably 3.0 or less. If a polymerization product having a dielectric constant of greater than 3.2 under conditions of a temperature of 23° C., frequency of 100 kHz and applied voltage of 100 mV is interposed between the touch sensor 104 and the image display portion 105, the change in electrostatic capacitance of the transparent optical resin layer as a result of touching the touch panel with a finger becomes large, resulting in an increased likelihood of an operational error occurring in the image display portion, and thereby making this undesirable.

The color coordinate b* value described in JIS Z 8729 of the polymerization product of present invention (III) present between two glass plates and adjusted to a thickness of 200 μm after storing under conditions of a temperature of 95° C. for 500 hours is preferably less than 1.5 and more preferably less than 1.0. In the case the color coordinate b* value is 1.5 or more, image color ends up changing in comparison with initial use during the course of continuous use of the image display device, thereby making this undesirable.

The polymerization product of present invention (III) having the properties described above can be obtained by, for example, polymerizing the polymerizable composition of present invention (I).

Next, an explanation is provided of the method for producing an image display device of present invention (IV).

Present invention (IV) is a method for producing an image display device containing a base portion having an image display portion, a light-transmitting protective portion, and a transparent optical resin layer interposed between the base portion and the protective portion; wherein, the method comprises:

a step for interposing the polymerizable composition of present invention (I) between the base portion and the protective portion, and

a step for forming a transparent optical resin layer by irradiating the polymerizable composition with light enabling photosensitization of a polymerization inhibitor.

The following provides a more detailed explanation of preferred embodiments of the image display device with reference to the drawings. Furthermore, in the drawings, the same reference symbols are used to indicate those constituents that are the same or equivalent.

FIG. 1 and FIG. 2 are cross-sectional views showing the essential portion of embodiments of the image display device according to the present invention. As shown in FIG. 1 and FIG. 2, the image display devices 101 and 102 of the present embodiments have an image display portion 105 connected to a drive circuit not shown that carries out a prescribed image display, a light-transmitting protective portion 103 arranged in opposition and in close proximity to the image display portion 105 at a prescribed distance therefrom, a touch sensor 104 that detects a change in electrostatic capacitance when touched with a finger, and a transparent optical resin layer 106. In the image display device 101, the transparent optical resin layer 106 is present between the light-transmitting protective portion 103 and the touch sensor 104 (transparent optical resin layer 106a) and between the touch sensor 104 and the image display portion 105 (transparent optical resin layer 106b), while in the image display device 102, is present between the touch sensor 104 and the image display portion 105. Accordingly, when a change in electrostatic capacitance of the transparent optical resin layer 106b of the image display device 101 or the transparent optical resin layer 106 of the image display device 102 is large, there is an increased likelihood of an operational error occurring in the image display portion 105, thereby requiring that the dielectric constant thereof be low.

Furthermore, there are no particular limitations on the “image display device” as referred to in the present description provided it is a device that displays images, and various types of devices can be applied thereto. Examples thereof include liquid crystal display devices of cell phones, portable game consoles and the like. The image display portion 105 of the present embodiments is a liquid crystal display panel of such a liquid crystal display device.

The following provides an explanation of a method for producing an image display device of the present embodiments. Furthermore, the phrase “between a base portion having an image display portion and a light-transmitting protective portion” as described in the present description refers to the entire portion between the image display portion 105 and the light-transmitting protective portion 103, and for example, means that both 106a and 106b in FIG. 1 are included in the expression of “between a base portion having an image display portion and a light-transmitting protective portion”.

The method for producing the image display device of the present embodiments consists of, for example, first dropping a prescribed amount of the polymerizable composition of present invention (I) onto the image display portion 105.

The light-transmitting protective portion 103 is then arranged on the image display portion 105, and the polymerizable composition of present invention (I) is completely filled into the gap between the image display portion 105 and the light-transmitting protective portion 103.

Subsequently, the transparent optical resin layer 106 is obtained by polymerizing the polymerizable composition of present invention (I) by irradiating the polymerizable composition of present invention (I) through the light-transmitting protective portion 103 with light enabling photosensitization of an essential component of the polymerizable composition of present invention (I) in the form of component (3). As a result, a target image display device is obtained.

Furthermore, in the case of providing the touch sensor 104 between the image display portion 105 and the light-transmitting protective portion 103, after having dropped a prescribed amount of the polymerizable composition of present invention (I) onto the image display portion 105, the touch sensor 104 is arranged thereon, and the polymerizable composition of present invention (I) is completely filled into the gap between the image display portion 105 and the touch sensor 104. Next, a prescribed amount of the polymerizable composition of present invention (I) is dropped onto the touch sensor 104, the light-transmitting protective portion 103 is arranged thereon, and the polymerizable composition of present invention (I) is completely filled into the gap between the touch sensor 104 and the light-transmitting protective portion 103, followed by obtaining a target image display device by obtaining the transparent optical resin layers 106a and 106b by polymerizing the polymerizable composition of present invention (I) by irradiating through the light-transmitting protective portion 103 with light capable of photosensitizing the polymerizable composition of present invention (I). In the case of not providing the transparent optical resin layer 106a between the touch sensor 104 and the light-transmitting protective portion 103, the latter dropping of the polymerizable composition of present invention (I) is not carried out.

According to this image display device, since the refractive indices of the transparent optical resin layer 106 and the light-transmitting protective portion 103 are equal, luminance and contrast can be enhanced and visibility can be improved.

In addition, since the effect of stress attributable to volumetric shrinkage during polymerization of the polymerizable composition on the light-transmitting protective portion 103 and the image display portion 105 can be minimized, there is hardly any occurrence of warping in the light-transmitting protective portion 103 and the image display portion 105, and as a result thereof, deformation does not occur in the image display portion 105, thereby making it possible to display images of high luminance and high contrast that are free of display defects.

In addition, in the case of obtaining the transparent optical resin layer 106b of FIG. 1 and the transparent optical resin layer 106 of FIG. 2 by polymerizing the polymerizable composition of present invention (I), since the dielectric constant of the transparent optical resin layer 106 is low, there is little change in electrostatic capacitance, and since the possibility of operational errors occurring in the image display portion 105 is lowered, images can be displayed that are free of display defects.

In addition, since heat-resistant coloring of the transparent optical resin layer 106 is favorable, images having high luminance and high contrast that are free of display defects can be displayed over a long period of time.

In addition, resistance to impacts is increased since the transparent optical resin layer 106 is present between the light-transmitting protective portion 103 and the image display portion 105.

Next, an explanation is provided of the method for producing an image display device of present invention (V).

Present invention (V) is a method for producing an image display device containing a base portion having an image display portion, a light-transmitting protective portion, and a transparent optical resin layer interposed between the base portion and the protective portion; wherein, the method comprises:

a step for interposing the polymerization product of present invention (III) between the base portion and the protective portion.

In the method for producing an image display device of present invention (V), the method for producing an image display device of the present embodiment consists of, for example, first dropping a prescribed amount of the polymerizable composition of present invention (I) onto the image display portion 105.

The light-transmitting protective portion 103 is then arranged on the image display portion 105, and the polymerizable composition of present invention (I) is completely filled into the gap between the image display portion 105 and the light-transmitting protective portion 103.

Subsequently, the polymerizable composition of present invention (I) is polymerized by irradiating the polymerizable composition of present invention (I) through the light-transmitting protective portion 103 with light enabling photosensitization of an essential component of the polymerizable composition of present invention (I) in the form of component (3). As a result, the transparent optical resin layer 106 is obtained composed of the polymerization product of present invention (III). As a result, a target image display device is obtained.

According to the method for producing an image display device of present invention (V), effects are obtained that are equivalent to those of the method for producing the image display device of present invention (IV).

Next, an explanation is provided of the optical adhesive sheet of present invention (VI).

Present invention (VI) is an optical adhesive sheet obtained by coating the polymerizable composition of present invention (I) to a thickness of 30 μm to 300 μm and polymerizing by irradiating the composition with light enabling photosensitization of a photopolymerization initiator.

The optical adhesive sheet of present invention (VI) may have a base material or may be a double-sided adhesive sheet composed only of an adhesive layer. In addition, the adhesive layer may be composed of a single layer or may be composed by laminating a plurality of layers. In particular, a double-sided adhesive sheet composed only of an adhesive layer and not having a base material is preferable from the viewpoints of ensuring transparency and shape followability.

The following provides an explanation of a specific example of a method for producing the optical adhesive sheet of present invention (VI). The optical adhesive sheet of present invention (VI) can be obtained by coating the polymerizable composition of present invention (I) onto a mold release PET film and curing the coated composition by irradiating with light enabling photosensitization of a photopolymerization initiator. The thickness of the optical adhesive sheet of present invention (VI) is preferably 5 μm to 500 μm and more preferably 30 μm to 300 μm. If the film thickness of the optical adhesive sheet of present invention (VI) is less than 5 μm, it becomes difficult to laminate the adhesive sheet, while if the film thickness is greater than 500 μm, it tends to become difficult to control film thickness.

In addition, the polymerizable composition of present invention (I) may also be in the form of a solution by using an organic solvent for the purpose of adjusting viscosity during coating. Examples of organic solvents used include methyl ethyl ketone, acetone, ethyl acetate, tetrahydrofuran, dioxane, cyclohexanone, n-hexane, toluene, xylene, n-propanol and isopropanol. These organic solvents may be used alone or two or more types may be mixed.

Next, an explanation is provided of the optical adhesive sheet of present invention (VII).

Present invention (VII) is an optical adhesive sheet used as a transparent optical resin layer interposed between the image display portion and light-transmitting protective portion of an image display device.

The dielectric constant of the optical adhesive sheet of present invention (VII) at 23° C. under conditions of a frequency of 100 kHz and applied voltage of 100 mV is preferably 3.2 or less and more preferably 3.0 or less. If an optical adhesive sheet having a dielectric constant of greater than 3.2 under conditions of a temperature of 23° C., frequency of 100 kHz and applied voltage of 100 mV is interposed between the touch sensor 104 and the image display portion 105, the change in electrostatic capacitance of the transparent optical resin layer as a result of touching the touch panel with a finger becomes large, resulting in an increased likelihood of an operational error occurring in the image display portion, and thereby making this undesirable.

The color coordinate b* value described in JIS Z 8729 of the optical adhesive sheet of present invention (VII) present between two glass plates and adjusted to a thickness of 200 μm after storing under conditions of a temperature of 95° C. for 500 hours is preferably less than 1.5 and more preferably less than 1.0. In the case the color coordinate b* value is 1.5 or more, image color ends up changing in comparison with initial use during the course of continuous use of the image display device, thereby making this undesirable.

The optical adhesive sheet of present invention (VII) having the properties described above can be obtained by, for example, coating the polymerizable composition of present invention (I) to a thickness of 30 μm to 300 μm and polymerizing by irradiating the composition with light enabling photosensitization of a photopolymerization initiator.

Next, an explanation is provided of the method for producing an image display device of present invention (VIII).

Present invention (VIII) is a method for producing an image display device containing a base portion having an image display portion, a light-transmitting protective portion, and a transparent optical resin layer interposed between the base portion and the protective portion; wherein, the method comprises:

a step for laminating the base portion and the protective portion using the optical adhesive sheet of present invention (VI) or present invention (VII).

An example of the method for producing an image display device of the present embodiment using the method for producing an image display device of present invention (VIII) consists of, for example, first adhering the optical adhesive sheet of present invention (VI) or present invention (VII) to the image display portion 105. The light-transmitting protective portion 103 is then laminated over the image display portion 105 with the optical adhesive sheet of present invention (VI) or present invention (VII) interposed there between. As a result, the transparent optical resin layer 106 is obtained comprised of the optical adhesive sheet of present invention (VI) or present invention (VII). As a result, a target optical display device is obtained.

Furthermore, in the case of providing the touch sensor 104 between the image display portion 105 and the light-transmitting protective portion 103, after having adhered the optical adhesive sheet of present invention (VI) or present invention (VII) on the image display portion 105, the touch sensor 104 is adhered thereto, followed by laminating the light-transmitting protective portion 103 either after adhering or without adhering the optical adhesive sheet of present invention (VI) or present invention (VII) to obtain a target optical display device.

According to the method for producing an image display device of present invention (VIII), effects are obtained that are equivalent to those of the method for producing an image display device of present invention (IV).

Next, an explanation is provided of the image display device of present invention (IX).

Present invention (IX) is an image display device produced according to any of the methods for producing an image display device of present invention (VI), present invention (V) and present invention (VIII).

The image display device of present invention (IX), in the case the body of a liquid crystal display panel is formed from optical glass, typically has a refractive index (η_{D}) of 1.49 to 1.52. Furthermore, reinforced glass having a refractive index (η_{D}) of about 1.55 may also be used.

The light-transmitting protective portion 103 is formed from a light-transmitting optical member in the form of a plate, sheet or film having a size roughly equal to that of the image display portion 105. Examples of this light-transmitting optical member that can be used preferably include optical glass and plastic (such as that made of an acrylic resin such as polymethyl methacrylate). An optical layer such as an antireflective film, light-blocking film or viewing angle control film may also be formed on the front or back of the protective portion 103.

In the case the light-transmitting protective portion 103 is formed from an acrylic resin, the refractive index (η_{D}) thereof is typically 1.49 to 1.51.

The light-transmitting protective portion 103, or the light-transmitting protective portion 103 and the touch sensor 104 integrated into a single unit therewith, can be provided on the image display portion 105 through a spacer provided on the peripheral portion of the image display portion 105. The thickness of this spacer is about 0.05 mm to 1.5 mm, and the inter-surface distance between the image display portion 105 and the light-transmitting protective portion 103 and touch sensor 104 integrated into a single unit therewith is maintained at about 1 mm as a result thereof.

In addition, a frame-like light blocking portion not shown is provided on the peripheral portion of the light-transmitting protective portion 103 and the touch sensor 104 integrated into a single unit therewith in order to improve luminance and contrast.

The transparent optical resin layer 106 is interposed between the image display portion 105 and the light-transmitting protective portion 103. This transparent optical resin layer 106 demonstrates transmittance of 90% or more in the visible range due to interposition of any of the polymerization product of present invention (III), the optical adhesive sheet of present invention (VI) and the optical adhesive sheet of present invention (VII). Here, the thickness of the transparent optical resin layer 106 is preferably 30 μm to 300 μm.

In addition, since the refractive index (η_{D}) at 25° C. of the transparent optical resin layer 106 is 1.45 to 1.55 and preferably 1.48 to 1.52 due to interposition of any of the polymerization product of present invention (III), the optical adhesive sheet of present invention (VI) and the optical adhesive sheet of present invention (VII), it is nearly equal to the refractive indices of the image display portion 105 and the light-transmitting protective portion 103, thereby making this preferable. As a result, the luminance and contrast of image light from the image display portion 105 can be enhanced and visibility can be improved.

The tensile elasticity at 23° C. of the transparent optical resin layer 106 is preferably 1×10⁷ Pa or less and more preferably 1×10³ Pa to 1×10⁶ Pa due to interposition of any of the polymerization product of present invention (II), the polymerization product of present invention (III), the optical adhesive sheet of present invention (VI) and the optical adhesive sheet of present invention (VII). As a result, the occurrence of warping due to the effect of stress attributable to volumetric shrinkage during polymerization of the polymerizable composition on the image display portion 105, the light-transmitting protective portion 103 and the touch sensor 104 integrated into a single unit therewith can be prevented.

The dielectric constant of the transparent optical resin layer 106b in the image display device 101 or the transparent optical resin layer 106 in the optical display device 102 at 23° C. under conditions of a frequency of 100 kHz and applied voltage of 100 mV is preferably 3.2 or less and more preferably 3.0 or less due to interposition of any of the polymerization product of present invention (II), the polymerization product of present invention (III), the optical adhesive sheet of present invention (VI) and the optical adhesive sheet of present invention (VII). As a result, there is little change in electrostatic capacitance, the possibility of operational errors occurring in the image display portion 105 is lowered, and images can be displayed that are free of display defects.

In addition, volumetric shrinkage of the transparent optical resin layer 106 during polymerization of the polymerizable composition of present invention (I) is preferably 4.0% or less and more preferably 3.0% or less due to interposition of the polymerization product of present invention (II) obtained by filling and photopolymerizing the polymerizable composition of present invention (I). As a result, internal stress that accumulates in the transparent optical resin layer during polymerization of the polymerizable composition can be reduced, and the occurrence of warping can be prevented at the interface between the transparent optical resin layer 106 and the light-transmitting protective portion 103 or between the transparent optical resin layer 106 and the image display portion 105. Thus, in the case of interposing the polymerizable composition between the image display portion 105 and the light-transmitting protective portion 103 and polymerizing that polymerizable composition, scattering of light occurring at the interface between the transparent optical resin layer 106 and the light-transmitting protective portion 103 or between the transparent optical resin layer 106 and the image display portion 105 can be reduced, thereby making it possible to enhance the luminance of displayed images while also improving visibility.

Here, an optical glass plate used as a glass plate used to sandwich the liquid crystal of a liquid crystal cell or used as a protective plate of a liquid crystal cell can be preferably used for the optical glass. In addition, an acrylic resin plate used as a protective plate of a liquid crystal cell can be used for the acrylic resin plate. The average surface roughness of this optical glass plate or acrylic resin plate is normally 1.0 nm or less.

In addition, impact resistance is demonstrated as a result of interposing the transparent optical resin layer 106 between the image display portion 105 and the light-transmitting protective portion 103 with any of the polymerization product of present invention (II), the polymerization product of present invention (III), the optical adhesive sheet of present invention (VI) and the optical adhesive sheet of present invention (VII).

In addition, various aspects can be adopted for the image display device of present invention (IX). For example, the image display device of present invention (IX) can not only be applied to a liquid crystal display device, but can also be applied to various types of panel displays such as an organic EL display device or plasma display device.

### EXAMPLES

Although the following provides a more detailed explanation of the present invention through examples thereof, the present invention is not limited to only the following examples.

<Measurement of Viscosity>

Viscosity was measured according to the method indicated below.

The value when viscosity became nearly constant was measured using a 1 mL sample and a cone and plate type viscometer (Model DV-11+ Pro, Brookfield Engineering Inc., spindle type: CPE-42) under conditions of a temperature of 25° C. and rotating speed of 10 rpm.

<Number Average Molecular Weight>

The value as polystyrene measured by GPC under the conditions indicated below was used for the value of number average molecular weight.

Apparatus: HPLC Unit HSS-2000 (Jasco Corp.)

Column: Shodex Column LF-804

Mobile phase: Tetrahydrofuran

Flow rate: 1.0 mL/min

Detector: RI-2031 Plus (Jasco Corp.)

Temperature: 40.0° C.

Sample volume: 100 μL sample loop

Sample concentration: Prepared to about 0.5% by weight

### Synthesis Example 1

180 g of hydrogenated terminal hydroxyl group-containing polybutadiene (hydroxyl value: 47.1 mgKOH/g, trade name: Nisso-PB GI-2000, Nippon Soda Co., Ltd.) and 20 mg of dioctyltin dilaurate were placed in a 300 mL separable flask equipped with a condenser, dropping funnel, thermometer and stirrer followed by raising the internal temperature to 50° C. using an oil bath. Subsequently, 22.86 g of 2-isocyanatoethyl methacrylate (trade name: Karenz MOI, Showa Denko K.K.) were dropped in over the course of 5 minutes using the dropping funnel. During dropping, the internal temperature was prevented from exceeding 70° C. Following completion of dropping, stirring was continued while controlling the internal temperature to 70° C.±2° C. Since absorption of stretching vibrations associated with C═O of the isocyanato group was no longer observed in the infrared absorption spectrum, stirring was discontinued to terminate the reaction and obtain urethane methacrylate (to be referred to as Urethane Methacrylate A). The viscosity of Urethane Methacrylate A at 25° C. was 94500 mPa·s.

### Synthesis Example 2

180 g of hydrogenated terminal hydroxyl group-containing polybutadiene (hydroxyl value: 47.1 mgKOH/g, trade name: Nisso-PB GI-3000, Nippon Soda Co., Ltd.) and 19 mg of dioctyltin dilaurate were placed in a 300 mL separable flask equipped with a condenser, dropping funnel, thermometer and stirrer followed by raising the internal temperature to 50° C. using an oil bath. Subsequently, 14.4 g of 2-isocyanatoethyl methacrylate (trade name: Karenz MOI, Showa Denko K.K.) were dropped in over the course of 5 minutes using the dropping funnel. During dropping, the internal temperature was prevented from exceeding 70° C. Following completion of dropping, stirring was continued while controlling the internal temperature to 70° C.±2° C. Since absorption of stretching vibrations associated with C═O of the isocyanato group was no longer observed in the infrared absorption spectrum, stirring was discontinued to terminate the reaction and obtain urethane methacrylate (to be referred to as Urethane Methacrylate B). The viscosity of Urethane Methacrylate B at 25° C. was 19900 mPa·s.

### Formulation Example 1

50 g of the aforementioned Urethane Methacrylate A, 49 g of lauryl acrylate (trade name: Blemmer LA, NOF Corp.), 1 g of pentaerythritol tetrakis[3-(3,5-di-tert-butyl-4-hydroxyphenyl)propionate] (trade name: Irganox™ 1010, BASF Corp.) and 1 g of 2,4,6-trimethylbenzoyl diphenyl phosphine oxide (trade name: SpeedCure TPO, Lambson Ltd.) were mixed using a revolving/rotating mixer (trade name: Awatori Rentaro, Thinky Co., Ltd.). This formulation was designated as Polymerizable Composition A1. The viscosity of Polymerizable Composition A1 at 25° C. was 2500 mPa·s.

### Formulation Examples 2 to 5 and Formulation Comparative Examples 1 and 2

Components in accordance with the formulated compositions shown in Table 1 were formulated according to the same method as that of Formulation Example 1. The formulations prepared in Formulation Examples 2 to 5 were designated as Polymerizable Compositions A2 to A5, and the formulations prepared in Formulation Comparative Examples 1 and 2 were designated as Polymerizable Composition B1 and Polymerizable Composition B2.

Furthermore, the units of the numbers for each component of the formulation examples and formulation comparative examples shown in Table 1 are “parts by weight”.

TABLE 1

| | | | | | | Form. | Form. |
|---|---|---|---|---|---|---|---|
| | Form. Ex. 1 | Form. Ex. 2 | Form. Ex. 3 | Form. Ex. 4 | Form. Ex. 5 | Comp. Ex. 1 | Comp. Ex. 2 |
| Formulated Composition | A1 | A2 | A3 | A4 | A5 | B1 | B2 |
| Urethane methacrylate A | 50.0 | 38.0 | 20.0 | | | | |
| Urethane methacrylate B | | | | 20.0 | 15.0 | | |
| Urethane methacrylate UV | | | | | | 50.0 | |
| UV-3000B*¹ | | | | | | | |
| Kuraprene ™ UC-203*² | | | | | | | 70.0 |
| Isobornyl acrylate*³ | | | | | | 30.0 | |
| Dicyclopentenyloxyethyl | | | | | | | 30.0 |
| methacrylate*⁴ | | | | | | | |
| Lauryl acrylate*⁵ | 49.0 | 20.0 | 20.0 | 20.0 | 20.0 | | |
| 2-hydroxypropyl | | | | | 4.0 | | |
| methacrylate*⁶ | | | | | | | |
| 2-hydroxybutyl methacrylate*⁷ | | | | | | | 10.0 |
| Terpene-based hydrogenated | | | | | | | 30.0 |
| resin Clearon ™ P85*⁸ | | | | | | | |
| Terpene-based hydrogenated | | 14.0 | 14.0 | 14.0 | 14.0 | | |
| resin Clearon ™ P105*⁹ | | | | | | | |
| Terpene-based hydrogenated | | 14.0 | 14.0 | 14.0 | 14.0 | | |
| resin Clearon ™ M105*¹⁰ | | | | | | | |
| Hydrogenated polybutadiene | | | | | 32.0 | | |
| polyol GI-2000*¹¹ | | | | | | | |
| Hydrogenated polybutadiene | | 13.0 | 27.0 | 25.0 | | | |
| BI-2000*¹² | | | | | | | |
| Polyvest 110*¹³ | | | 4.0 | 6.0 | | | 140.0 |
| Irganox 1010*¹⁴ | 1.0 | 1.0 | 1.0 | 1.0 | 1.0 | | 0.3 |
| Photopolymerization initiator | 1.0 | 1.0 | 1.0 | 1.0 | 1.0 | 1.0 | 0.5 |
| SpeedCure TPO*¹⁵ | | | | | | | |
| Photopolymerization initiator | | | | | | 3.0 | 4.0 |
| Irgacure 184*¹⁶ | | | | | | | |
| Polymerizable composition | 2500 mPa · s | 4500 mPa · s | 4000 mPa · s | 4000 mPa · s | 4000 mPa · s | 3000 mPa · s | 3500 mPa · s |
| viscosity (25° C.) | | | | | | | |

*¹Urethane methacrylate UV UV-3000B (polyester type of urethane methacrylate, Nippon Synthetic Chemical Co., Ltd.)
*²Kuraprene UC-203 (esterification product of maleic anhydride adduct of polyisoprene and 2-hydroxyethyl methacrylate, Kuraray Co., Ltd.)
*³Isobornyl acrylate (trade name: IBXA, Osaka Organic Chemical Industry, Ltd.)
*⁴Dicyclopentenyloxyethyl methacrylate (trade name: FA-512M, Hitachi Chemical Co., Ltd.)
*⁵Lauryl acrylate (trade name: Blemmer LA, NOF Corp.)
*⁶2-hydroxypropyl methacrylate (trade name: HPMA, Mitsubishi Rayon Co., Ltd.)
*⁷2-hydroxybutyl methacrylate (trade name: Light Ester HOB(N), Kyoeisha Chemical Co., Ltd.)
*⁸Terpene-based hydrogenated resin Clearon ™ P85 (Yasuhara Chemical Co., Ltd.)
*⁹Terpene-based hydrogenated resin Clearon ™ P105 (Yasuhara Chemical Co., Ltd.)
*¹⁰Terpene-based hydrogenated resin Clearon ™ M105 (Yasuhara Chemical Co., Ltd.)
*¹¹Hydrogenated polybutadiene polyol GI-2000 (Nippon Soda Co., Ltd.
*¹²Hydrogenated polybutadiene BI-2000 (Nippon Soda Co.,Ltd.)
*¹³Polyvest 110 (chemical name: liquid polybutadiene, Evonik Degussa Japan Co., Ltd.)
*¹⁴Irganox 1010 (chemical name: pentaerythritol tetrakis[3-(3,5-di-tert-butyl-4-hydroxyphenyl) propionate], BASF Corp.)
*¹⁵Photopolymerization initiator SpeedCure TPO (chemical name: 2,4,6-trimethylbenzoyl diphenyl phosphine oxide, Lambson Ltd.)
*¹⁶Photopolymerization initiator Irgacure 184 (chemical name: 1-hydroxycyclohexyl phenyl ketone, BASF Corp.)

<Test Piece Fabrication Method and Evaluation of Initial Optical Properties>

The aforementioned Polymerizable Compositions A1 to A5, Polymerizable Composition B1 and Polymerizable Composition B2 were respectively coated onto a glass plate (50 mm×50 mm×0.7 mm, glass type: trade name: Eagle XG™, Corning Inc.) using a bar coater to a film thickness of 200 μm followed by sandwiching with a glass plate of the same type and shape and polymerizing by irradiating through the glass plate with ultraviolet light under conditions of a radiant intensity of 190 mW/cm² (value at 365 nm) and radiation dose of 2800 mJ/cm² (value at 365 nm) using a conveyor-type ultraviolet radiation device equipped with a metal halide lamp (GS Yuasa Lighting Co., Ltd., trade name: GSN2-40) to obtain polymerization product films for evaluation and testing having a film thickness of about 200 μm sandwiched between glass plates. Polymerization product films for evaluation and testing having a film thickness of about 200 μm sandwiched between glass plates produced using Polymerizable Compositions A1 to A3, Polymerizable Composition B1 and Polymerizable Composition B2 were designated as Test Pieces A1 to A5, Test Piece B1 and Test Piece B2, respectively. The total light transmittance and b* value of these test pieces were measured according to the methods to be subsequently described. The results are shown in Table 3.

<Measurement of Total Light Transmittance>

The total light transmittances of the aforementioned Test Pieces A1 to A5, Test Piece B1 and Test Piece B2 were measured in compliance with JIS K 7361-1 using distilled water sandwiched between two glass plates (50 mm×50 mm×0.7 mm, glass type: trade name: Eagle XG™, Corning Inc.) at a thickness of 200 μm as a reference.

<Measurement of b* Value>

The b* values of the aforementioned Test Pieces A1 to A5, Test Piece B1 and Test Piece B2 were measured in compliance with JIS Z 8729 using distilled water sandwiched between two glass plates (50 mm×50 mm×0.7 mm, glass type: trade name: Eagle XG™, Corning Inc.) at a thickness of 200 μm as a reference.

<Measurement of Haze>

The haze values of the aforementioned Test Pieces A1 to A5, Test Piece B1 and Test Piece B2 were measured in compliance with JIS K 7136 using distilled water sandwiched between two glass plates (50 mm×50 mm×0.7 mm, glass type: trade name: Eagle XG™, Corning Inc.) at a thickness of 200 μm as a reference.

<Measurement of Refractive Index>

The aforementioned Polymerizable Compositions A1 to A5, Polymerizable Composition B1 and Polymerizable Composition B2 were sandwiched between two silicone-coated polyethylene terephthalate films at a film thickness of 200 μm, and polymerized by irradiating through the silicone-coated polyethylene terephthalate film with ultraviolet light under conditions of a radiant intensity of 190 mW/cm² (value at 365 nm) and radiation dose of 2800 mJ/cm² (value at 365 nm) using a conveyor-type ultraviolet radiation device equipped with a metal halide lamp (GS Yuasa Lighting Co., Ltd., trade name: GSN2-40) to obtain polymerization product films for evaluation and testing having a film thickness of about 200 μm sandwiched between silicone-coated polyethylene terephthalate films. The polymerization product films were peeled from the silicone-coated polyethylene terephthalate film and measured in compliance with JIS K 7105. The results are shown in Table 2.

<Measurement of Dielectric Constant>

The aforementioned Polymerizable Compositions A1 to A5, Polymerizable Composition B1 and Polymerizable Composition B2 were sandwiched between two silicone-coated polyethylene terephthalate films at a film thickness of 2 mm, and polymerized by irradiating through the silicone-coated polyethylene terephthalate film with ultraviolet light under conditions of a radiant intensity of 190 mW/cm² (value at 365 nm) and radiation dose of 2800 mJ/cm² (value at 365 nm) using a conveyor-type ultraviolet radiation device equipped with a metal halide lamp (GS Yuasa Lighting Co., Ltd., trade name: GSN2-40) to obtain polymerization product films for evaluation and testing having a film thickness of about 2 mm sandwiched between silicone-coated polyethylene terephthalate films. The polymerization product films were peeled from the silicone-coated polyethylene terephthalate film and measured using an impedance analyzer (trade name: 4294A Precision Impedance Analyzer, 40 Hz to 110 MHz, Agilent Technologies Inc.). The results are shown in Table 2.

Furthermore, the polymerization product films peeled from the silicone-coated polyethylene terephthalate films obtained by polymerizing Polymerizable Compositions A1 to A5, Polymerizable Composition B1 and Polymerizable Composition B2 were designated as Polymerization Product Films A1 to A5, Polymerization Product Film B1 and Polymerization Product Film B2, respectively.

<Measurement of Volumetric Shrinkage during Polymerization>

The densities of Polymerizable Compositions A1 to A5, Polymerizable Composition B1 and Polymerizable Composition B2 prior to polymerization and polymerization products thereof (namely, Polymerization Product Films A1 to A5, Polymerization Product Film B1 and Polymerization Product Film B2) were measured under temperature conditions of 23° C. using an automatic densitometer (Model DMA-220H, Shinko Denshi Co., Ltd.) followed by determining volumetric shrinkage during polymerization using the equation indicated below.

Volumetric shrinkage during polymerization(%)=(density of polymerization product−density of polymerizable composition)/(density of polymerization product)×100

The results are shown in Table 2.

<Measurement of Tensile Elasticity>

Testing was carried out on Polymerization Product Films A1 to A5, Polymerization Product Film B1 and Polymerization Product Film B2 at 23° C. and tension speed of 500 mm/min by mounting on a tension tester (EZ Test/CE, Shimadzu Corp.) followed by determination of tensile elasticity. The results are shown in Table 2.

<Measurement of Total Light Transmittance and b* Value when Stored Under High-Temperature Conditions>

The aforementioned Test Pieces A1 to A5, Test Piece B1 and Test Piece B2 were placed in a constant temperature chamber at a temperature of 70° C., 85° C. and 95° C., respectively, followed by measurement of total light transmittance and b* value according to the previously described methods using test pieces for which 500 hours had elapsed. The results are shown in Table 3.

TABLE 2

| Polymerizable composition | A1 | A2 | A3 | A4 | A5 | B1 | B2 |
|---|---|---|---|---|---|---|---|
| Polymerization product film | A1 | A2 | A3 | A4 | A5 | B1 | B2 |
| Volumetric shrinkage during | 3.8% | 1.9% | 1.8% | 2.0% | 2.3% | 4.5% | 1.8% |
| polymerization | | | | | | | |
| Refractive index of polymerization | 1.49 | 1.49 | 1.49 | 1.49 | 1.50 | 1.47 | 1.52 |
| product film (η_{D}) | | | | | | | |
| Tensile elasticity (23° C.) | 1.4 × 10⁵ Pa | 1.2 × 10⁵ Pa | 1.2 × 10⁵ Pa | 1.3 × 10⁵ Pa | 1.3 × 10⁵ Pa | 1.0 × 10⁵ Pa | 1.0 × 10⁵ Pa |
| Polymerization product film dielectric | 2.8 | 2.8 | 2.9 | 2.9 | 2.9 | 3.4 | 3.0 |
| constant (23° C., 100 kHz, 100 mV) | | | | | | | |

TABLE 3

| | | Temperature Conditions | | | | | |
|---|---|---|---|---|---|---|---|
| | | 70° C. | 85° C. | 95° C. | 70° C. | 85° C. | 95° C. |
| | | Immediately after | | | 500 hours after | | |
| | | polymerization (0 hr) | | | polymerization | | |
| Test Piece A1 | b* | 0.20 | 0.20 | 0.19 | 0.20 | 0.33 | 0.36 |
| | Total light | 100 | 100 | 100 | 100 | 100 | 100 |
| | transmittance | | | | | | |
| | Haze | 0.11 | 0.13 | 0.13 | 0.00 | 0.00 | 0.00 |
| Test Piece A2 | b* | 0.21 | 0.19 | 0.19 | 0.20 | 0.29 | 0.39 |
| | Total light | 100 | 100 | 100 | 100 | 100 | 100 |
| | transmittance | | | | | | |
| | Haze | 0.14 | 0.13 | 0.13 | 0.00 | 0.00 | 0.00 |
| Test Piece A3 | b* | 0.21 | 0.20 | 0.19 | 0.20 | 0.31 | 0.38 |
| | Total light | 100 | 100 | 100 | 100 | 100 | 100 |
| | transmittance | | | | | | |
| | Haze | 0.21 | 0.13 | 0.13 | 0.00 | 0.00 | 0.00 |
| Test Piece A4 | b* | 0.20 | 0.21 | 0.17 | 0.21 | 0.36 | 0.36 |
| | Total light | 100 | 100 | 100 | 100 | 100 | 100 |
| | transmittance | | | | | | |
| | Haze | 0.14 | 0.12 | 0.11 | 0.10 | 0.00 | 0.00 |
| Test Piece A5 | b* | 0.19 | 0.18 | 0.14 | 0.19 | 0.37 | 0.32 |
| | Total light | 100 | 100 | 100 | 100 | 100 | 100 |
| | transmittance | | | | | | |
| | Haze | 0.00 | 0.03 | 0.03 | 0.10 | 0.27 | 0.60 |
| Test Piece B1 | b* | 0.22 | 0.22 | 0.22 | 0.23 | 0.27 | 0.60 |
| | Total light | 100 | 100 | 100 | 100 | 100 | 100 |
| | transmittance | | | | | | |
| | Haze | 0.21 | 0.21 | 0.21 | 0.00 | 0.00 | 0.11 |
| Test Piece B2 | b* | 0.19 | 0.19 | 0.19 | 0.32 | 0.40 | 0.90 |
| | Total light | 100 | 100 | 100 | 100 | 100 | 100 |
| | transmittance | | | | | | |
| | Haze | 0.07 | 0.07 | 0.07 | 0.10 | 0.09 | 0.09 |

According to the results of Tables 2 and 3, the polymerizable composition of present invention (I) was determined to demonstrate little volumetric shrinkage during polymerization, and a polymerization product film obtained by polymerizing the polymerizable composition of present invention (I) was determined to be resistant to the occurrence of coloring, turbidity and other changes in appearance and be able to maintain favorable light transmittance even in the case of having been stored for a long period of time at high temperatures.

### INDUSTRIAL APPLICABILITY

As has been previously described, since the polymerizable composition of present invention (I) demonstrates little volumetric shrinkage during polymerization, and a polymerization product film obtained by polymerizing the polymerizable composition of present invention (I) is resistant to the occurrence of coloring, turbidity and other changes in appearance and is able to maintain favorable light transmittance even in the case of having been stored for a long period of time at high temperatures, a favorable optical adhesive layer can be provided in the case of using the polymerization product film as a transparent optical resin layer interposed between an image display portion and light-transmitting protective portion of an image display device.

Thus, the polymerization product is useful for use in image display devices.

### BRIEF DESCRIPTION OF THE REFERENCE SYMBOLS

101,102: Image display device
103: Light-transmitting protective portion
104: Touch sensor
105: Image display portion
106,106a,106b: Transparent optical resin layer

1. A polymerizable composition for forming a transparent optical resin layer interposed between an image display portion and a light-transmitting protective portion of an image display device; wherein, the polymerizable composition comprises:
(1) a urethane (meth)acrylate obtained by reacting a hydrogenated polyolefin polyol and a compound having an isocyanato group and a (meth)acryloyl group,
(2) a (meth)acryloyl group-containing compound having a hydrocarbon group having 6 or more carbon atoms, and
(3) a photopolymerization initiator.

2. The polymerizable composition according to claim 1, further comprising:
(4) at least one selected from the group consisting of a hydrogenated petroleum resin, a terpene-based hydrogenated resin, a hydrogenated rosin ester and a hydrogenated polyolefin.

3. The polymerizable composition according to claim 1, further comprising:
(5) a (meth)acryloyl group-containing compound having an alcoholic hydroxyl group.

4. The polymerizable composition according to claim 1, further comprising:
(6) a hydrogenated polyolefin polyol.

5. The polymerizable composition according to claim 1 further comprising:
(7) a non-hydrogenated polyolefin.

6. A polymerization product obtained by polymerizing the polymerizable composition according to claim 1.

7. A polymerization product used as a transparent optical resin layer interposed between an image display portion and a light-transmitting protective portion of an image display device; wherein, the dielectric constant of the polymerization product under conditions of a temperature of 23° C., frequency of 100 kHz and applied voltage of 100 mV is 3.0 or less, and the color coordinate b* value described in JIS Z 8729 of the polymerization product present between two glass plates and adjusted to a thickness of 200 μm after storing under conditions of a temperature of 95° C. for 500 hours is less than 1.0.

8. A method for producing an image display device containing a base portion having an image display portion, a light-transmitting protective portion, and a transparent optical resin layer interposed between the base portion and the protective portion; wherein, the method comprises:
a step for interposing the polymerizable composition according to claim 1 between the base portion and the protective portion, and
a step for forming a transparent optical resin layer by irradiating the polymerizable composition with light enabling photosensitization of a photopolymerization inhibitor.

9. A method for producing an image display device containing a base portion having an image display portion, a light-transmitting protective portion, and a transparent optical resin layer interposed between the base portion and the protective portion; wherein, the method comprises:
a step for interposing the polymerization product according to claim 7 between the base portion and the protective portion.

10. A polymerizable composition for producing an optical adhesive sheet used as a transparent optical resin layer interposed between an image display portion and a light-transmitting protective portion of an image display device, wherein the polymerizable composition is the polymerizable composition according to claim 1.

11. An optical adhesive sheet obtained by coating the polymerizable composition according to claim 10 to a thickness of 30 μm to 300 μm, irradiating the composition with light enabling photosensitization of a photopolymerization initiator, and polymerizing.

12. An optical adhesive sheet used as a transparent optical resin layer interposed between an image display portion and a light-transmitting protective portion of an image display device; wherein, the dielectric constant of the optical adhesive sheet under conditions of a temperature of 23° C., frequency of 100 kHz and applied voltage of 100 mV is 3.0 or less, and the color coordinate b* value described in JIS Z 8729 of the polymerization product present between two glass plates and adjusted to a thickness of 200 μm after storing under conditions of a temperature of 95° C. for 500 hours is less than 1.0.

13. A method for producing an image display device containing a base portion having an image display portion, a light-transmitting protective portion, and a transparent optical resin layer interposed between the base portion and the protective portion; wherein, the method comprises:
a step for laminating the base portion and the protective portion using the optical adhesive sheet according to claim 11.

14. An image display device produced according to the method for producing an image display device according to claim 8.

15. The polymerizable composition according to claim 2, further comprising:
(5) a (meth)acryloyl group-containing compound having an alcoholic hydroxyl group.

16. The polymerizable composition according to claim 2, further comprising:
(6) a hydrogenated polyolefin polyol.

17. The polymerizable composition according to claim 3, further comprising:
(6) a hydrogenated polyolefin polyol.

18. The polymerizable composition according to claim 2, further comprising:
(7) a non-hydrogenated polyolefin.

19. The polymerizable composition according to claim 3, further comprising:
(7) a non-hydrogenated polyolefin.

20. The polymerizable composition according to claim 4, further comprising:
(7) a non-hydrogenated polyolefin.

21. A method for producing an image display device containing a base portion having an image display portion, a light-transmitting protective portion, and a transparent optical resin layer interposed between the base portion and the protective portion; wherein, the method comprises:
a step for laminating the base portion and the protective portion using the optical adhesive sheet according to claim 12.

22. An image display device produced according to the method for producing an image display device according to claim 9.
